(19) United States
(12) Patent Application Publication
(10) Pub. No.: US 2011/0286666 A1
(43) Pub. Date: Nov. 24, 2011

(54) Image Sharpening

(76) Inventor: Ali Alsam, Levanger (NO)

(21) Appl. No.: 13/063,160

(22) PCT Filed: Sep. 9, 2008
(86) PCT No.: PCT/EP2008/061949

§ 371 Date: Aug. 9, 2011

(51) Int. Cl. G06K 9/00

(52) U.S. Cl. 382/167

(57) ABSTRACT

Provided is a method for sharpening an image, said image comprising a plurality of pixels, each pixel having at least a first value for a first color channel and a second value for a second color channel, the method comprising:
selecting a first pixel;
calculating an average projection of vectors defined by first values and second values of pixels in a region surrounding said first pixel onto a first vector, said first vector defined by said first value and said second value of said first pixel;
adjusting said first value and said second value of said first pixel using said average projection.

### FIELD OF THE INVENTION

The present invention relates generally to the field of image processing and more specifically to the sharpening of an image.

### BACKGROUND

It is often desirable to sharpen a digital image. One technique for sharpening a digital image is unsharp masking. In the technique of unsharp masking, pixel values for a blurred image are subtracted from pixel values for the original image to obtain pixel values for high spatial frequency components of the image. This high spatial frequency component is then added to the original image to give a sharpened version of the original image. The process of unsharp masking takes place for each color channel of a digital image separately. This leads to color artifacts being introduced to a sharpened image at color edges, and changes in the hue of the image elsewhere.

U.S. Pat. No. 5,793,885 discloses a process for sharpening a digital image. The process involves spatially filtering pixels of an RGB image by applying a high pass filter to the image. First, signals representative of luminance are extracted from the input image. Then, the extracted luminance signals are filtered.

### SUMMARY OF THE INVENTION

In accordance with an embodiment of the present invention, there is provided a method for sharpening an image. The image comprises a plurality of pixels, and each pixel has at least a first value for a first color channel and a second value for a second color channel. The method comprises selecting a first pixel. The method further comprises calculating an average projection of vectors defined by first and second values of pixels in a region surrounding the first pixel onto a first vector. The first vector is defined by the first value and the second value of the first pixel. The method further comprises adjusting the first value and the second value of the first pixel using the average projection.

Embodiments of the present invention are particularly advantageous as all color edges of the image are sharpened. Even color edges between pixels having similar luminance values are sharpened. Further, embodiments of the present invention allow images to be sharpened while maintaining the hue of the image, and without the introduction of fringing.

According to an embodiment of the present invention, the method further comprises the step of calculating a projection matrix. The projection matrix is a projection onto a first vector.

According to an embodiment of the present invention, the step of calculating the average projection comprises calculating the sum of each of the vectors defined by the first values and the second values of pixels in a region surrounding a first pixel multiplied by the projection matrix.

According to an embodiment of the present invention, the method further comprises calculating a difference vector by subtracting the average projection from the first vector.

According to an embodiment of the present invention, the step of adjusting the first value and the second value comprises adding the difference vector multiplied by a scalar to the first vector.

According to an embodiment of the present invention, the method further comprises receiving a user input of the scalar.

According to an embodiment of the present invention, the method further comprises receiving a user input indicating the region.

According to an embodiment of the present invention, each pixel of the plurality of pixels has three color channels.

According to an embodiment of the present invention, the method further comprises converting the image to a monochrome image. The pixels of the monochrome image have one value.

According to an embodiment of the present invention, there is provided an image processing system. The image processing system comprises a projection calculation component operable to calculate an average projection of a plurality of vectors onto a first vector. The first vector comprises values for at least two color channels of a first pixel of an image. Each vector of the plurality of vectors comprises values for at least two color channels of a pixel in a region of said image surrounding the first pixel. The image processing system further comprises a pixel value modification component operable to modify the values for the at least two color channels using the average projection.

According to an embodiment of the present invention, there is provided a computer program product comprising computer readable instructions which when executed on a computer cause the computer to execute a method for sharpening a first pixel. The first pixel has a first location on an image. The image comprises a plurality of pixels. Each pixel of the plurality of pixels has values for at least two color channels.

The method comprises defining a region around the first location on the image. The method further comprises calculating an average projection of vectors defined by the values of pixels in the region onto a first vector defined by the values of the first pixel. The method further comprises adjusting the values of the first pixel using the average projection.

### BRIEF DESCRIPTION OF THE DRAWINGS

In the following, embodiments of the invention will be described, by way of example only, and with reference to the drawings in which:

FIG. 1 shows a block diagram of an image processing system,

FIG. 2 shows vectors representing pixel values,

FIG. 3 shows projections of vectors representing pixel values onto a vector,

FIG. 4 shows a flow diagram illustration steps involved in a method of sharpening an image,

FIG. 5 shows a flow diagram illustrating steps involved in a method of sharpening an image.

### DETAILED DESCRIPTION

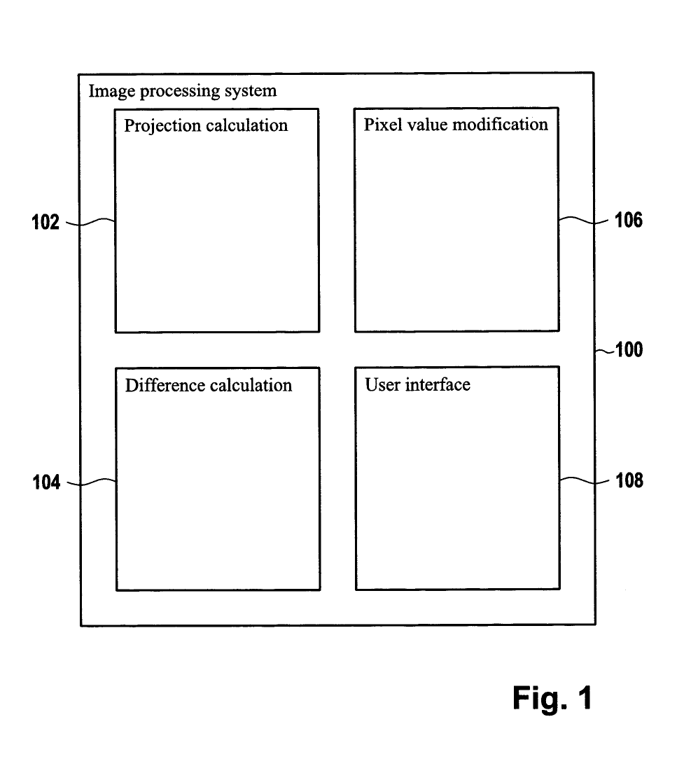

FIG. 1 shows image processing system 100. Image processing system 100 comprises projection calculation component 102, difference calculation component 104, pixel value modification component 106 and user interface 108. Image processing system 100 is operable to sharpen the pixel values of an image. Projection calculation component 102 is operable to calculate the projection of a plurality of vectors onto a first vector. The first vector comprises values for at least two color channels of a first pixel of an image. Each vector of the plurality of vectors comprises values for at least two color channels of a pixel in a region of the image surrounding the first pixel.

Difference calculation component 104 is operable to calculate a difference vector by subtracting the average projection of the plurality of vectors from the first vector. Pixel value modification component 106 is operable to modify the values of the first pixel. This modification results in a sharpened image. Pixel value modification component 106 uses the difference vector calculated by difference calculation component 104 to modify the values of the pixel.

User interface 108 may be operable to receive user input of a scalar. The scalar may be used by pixel value modification component to determine the degree of sharpening of the image. This degree of sharpening of the image may be determined by multiplying the scalar input by a user into user interface 108 by a vector calculated by difference calculation component 104.

User interface 108 may be further operable to receive a user input defining the region over which the vectors of pixels are projected onto the vector of the first pixel. This may include both defining the size of the region and the shape of the region.

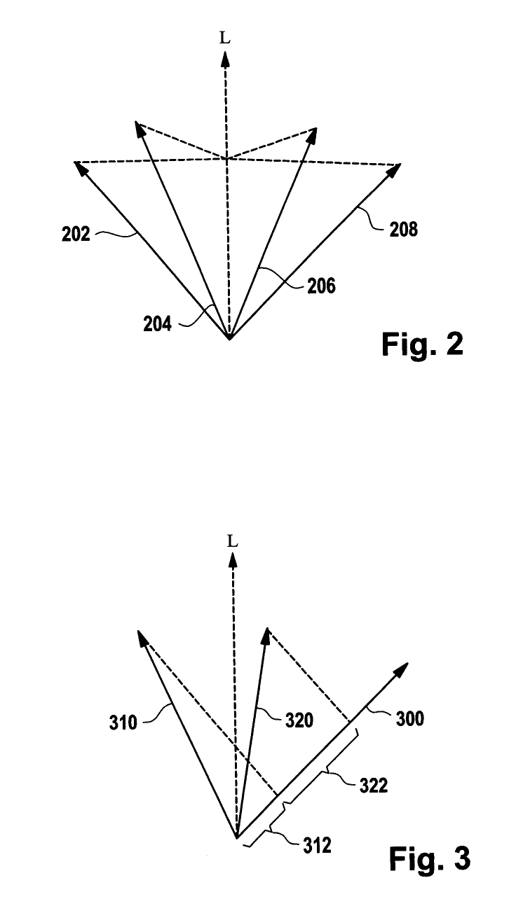

Image processing system 100 produces sharpened images in which all color edges of an image are sharpened. Further, image processing system 100 produces images which preserve the hue of the original image. These advantages are discussed with respect to FIGS. 2 and 3 below.

In the following description, the term a vector defined by a pixel is used describe a vector having the values of that pixel. This may be defined as a vector from the origin through a point having the pixel values in a Cartesian coordinate system defined by the axes of the color space. For example in the RGB color space a pixel having a red value, R, a green value, G, and a blue value, B, would have a vector (R, G, B) which would run from the origin (0,0,0) to the point (R, G, B).

FIG. 2 shows vectors 202, 204, 206 and 208. These vectors may be considered as representing pixel values in a color space. For example this may be the RGB color space. FIG. 2 also shows the projections of the vectors 202, 204, 206 and 208 onto a luminance axis, L. The four vectors shown in FIG. 2 all have the same projection onto the luminance axis L. All four vectors however represent different colors or different hues as they have different angles relative to the luminance axis L. Methods of sharpening images which only take into account differences in luminance between pixels would not sharpen any differences between vectors 202, 204, 206 and 208 as these all have the same projection onto the luminance axis L. Thus, methods of sharpening digital images which only take into account the luminance of pixels do not sharpen all color edges in an image.

FIG. 3 shows vector 300 representing the values of a first pixel, and the projections of vectors 310 and 320 onto vector 300. The projection of vector 310 onto vector 300 is 312 and the projection of vector 320 onto vector 300 is 322. Embodiments of the present invention take into account the projections of vectors of pixels surrounding a first pixel onto the vector of a first pixel, rather than the luminance and the projections of vectors onto the luminance axis. Therefore, embodiments of the present invention will sharpen all color edges. Further, embodiments of the present invention involve the addition of a vector or the subtraction of a vector in the same direction as the vector of a pixel under consideration in order to sharpen the image so the direction of the vector which represents the hue of the pixel will not be modified.

Experiments have shown that embodiments of the present invention have the further advantage that they do not result in the introduction of obvious halos which are typical of over sharpening in other sharpening methods. This is in part due to the asymmetry of the method used in embodiments of the present invention in that pixels either side of a color edge will project differently onto the hue axis of the other, which is not the case under prior art methods where the effect is essentially equal and opposite on either side of a color edge.

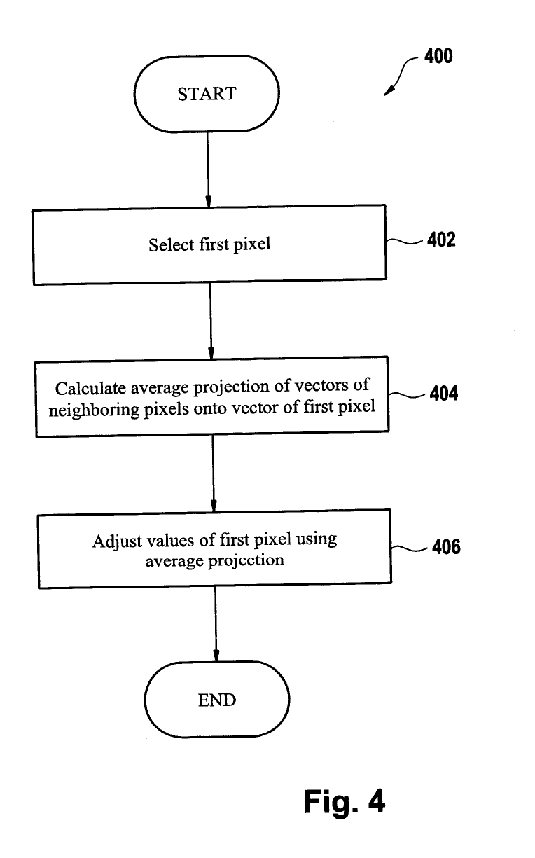

FIG. 4 shows a method 400 for sharpening an image. In step 402 a first pixel of the image is selected. In step 404, the average projection of vectors of the values of neighboring pixels onto the vector of the first pixel is calculated. In step 406, the values of the first pixel are adjusted using the average projection.

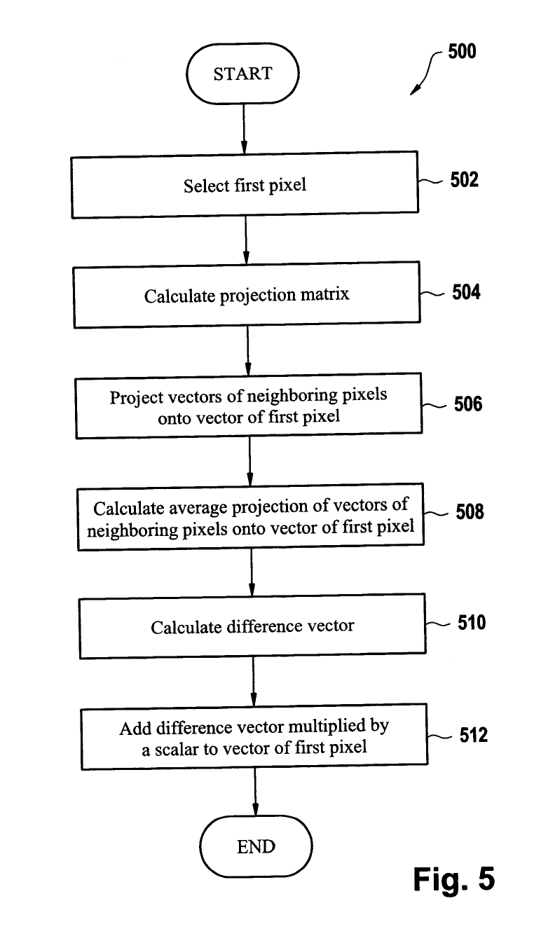

FIG. 5 shows a method 500 for sharpening an image. In step 502, a first pixel is selected. In step 504, a projection matrix is calculated. The projection matrix is a matrix projecting an arbitrary vector onto a vector defined by the values of the color channels of the first pixel. The projection matrix may be an orthogonal or non orthogonal projection onto the vector defined by the color channels of the first pixel. An example of an orthogonal projection matrix is given by the following formula.

$$P = \frac{p ( x , y ) {p}^{T} ( x , y )}{{‖ p ( x , y ) ‖}^{2}}$$

Where P is a square matrix with dimensions being the number of color channels in the image, p(x,y) is the color vector at location x,y on the image and ∥p(x,y)∥² is the second norm of p(x,y).

In step 506, vectors of neighboring pixels are projected onto the vector of the first pixel. In step 508, the average projection of vectors of neighboring pixels onto the vector of the first pixel is calculated. This may be defined by the following equation:

$${p}_{ave} = \frac{1}{n * m} {\sum }_{i = 1}^{n} {\sum }_{j = 1}^{m} Pp ( i , j )$$

Where n and m are the dimensions of a block over which the average projection pₐᵥₑ is calculated and p(i,j) is the vector of a pixel at location (i,j).

In step 510 a difference vector, d representing the difference between the first pixel and the average projection of the surrounding pixels is calculated using the following formula:

d=p(x,y)−pₐᵥₑ

In step 512, a pixel value for the first pixel in a sharpened image is obtained by adding the difference vector multiplied by a scaler to the vector of the first pixel:

p_{new}(x,y)=p(x,y)+αd

Where p_{new}(x,y) is the new vector of the pixel values and α is a scalar. The values of p_{new}(x,y) may be adjusted to ensure that they do not exceed those allowed by the system used for storing pixel values. For example image channels may have allowed values between 0 and 1, or in a different system, 0 and 255. Values outside these ranges may be reduced to the threshold values.

The method may further comprise the step of converting the resulting color image to a monochrome image. This may be realized by taking a weighted sum of the color channels for each pixel as the monochrome value for that pixel.

Embodiments of the present invention therefore provide methods and systems for obtaining a sharpened image in which all color edges are preserved. Embodiments of the present invention may be implemented as hardware, and as software. The method may be implemented as a computer program product comprising computer readable instructions which when executed on a computer or image processing device cause the computer or image processing device to execute the methods described above.

### LIST OF REFERENCE NUMERALS

100 image processing system
102 projection calculation component
104 difference calculation component
106 value modification component
108 user interface
202 vector
204 vector
206 vector
208 vector
300 vector
310 vector
312 projection of vector
320 vector
322 projection of vector
400 method
402 select first pixel
404 calculate average projection of vectors of neighboring pixels
406 adjust values of first pixel
500 method
502 select first pixel
504 calculate projection matrix
506 project vectors of neighboring pixels onto vector of first pixel
508 calculate average projection of vectors of neighboring pixels
510 calculate difference vector
512 add difference vector multiplied by scalar to vector of first pixel

1. A method for sharpening an image, said image comprising a plurality of pixels, each pixel having at least a first value for a first color channel and a second value for a second color channel, the method comprising:
selecting a first pixel;
calculating an average projection of vectors defined by first values and second values of pixels in a region surrounding said first pixel onto a first vector, said first vector defined by said first value and said second value of said first pixel;
adjusting said first value and said second value of said first pixel using said average projection.

2. The method of claim 1, further comprising the step of calculating a projection matrix, said projection matrix being a projection onto said first vector.

3. The method of claim 1, wherein the step of calculating said average projection comprises projecting each of said vectors defined by first values and second values of pixels in a region surrounding said first pixel onto said first vector.

4. The method of claim 1, further comprising calculating a difference vector by subtracting said average projection from said first vector.

5. The method of claim 4, wherein said step of adjusting said first value and said second value comprises adding said difference vector multiplied by a scalar to said first vector.

6. The method of claim 5, further comprising receiving a user input of said scalar.

7. The method of claim 1, further comprising receiving a user input indicating said region.

8. The method of claim 1, each pixel of said plurality of pixels having three color channels.

9. The method of claim 1, further comprising the step of converting the image to a monochrome image, pixels of said monochrome image having one value.

10. An image processing system, comprising:
a projection calculation component operable to calculate an average projection of a plurality of vectors onto a first vector, said first vector comprising values for at least two color channels of a first pixel of an image, each vector of said plurality of vectors comprising values for at least two color channels of a pixel in a region of said image surrounding the first pixel;
a pixel value modification component operable to modify said values for said at least two color channels using said average projection.

11. The image processing system of claim 10, the projection calculation component being further operable to calculate a projection matrix, said projection matrix being a projection onto said first vector.

12. The image processing system of claim 10, further comprising a difference calculation component operable to calculate a difference vector by subtracting said average projection from said first vector.

13. The image processing system of claim 12, wherein said pixel value modification component is operable to modify said at least two color channels by adding said difference vector multiplied by a scalar to said first vector.

14. The image processing system of claim 13, further comprising a user interface operable to receive a user input of said scalar.

15. A computer program product comprising computer readable instructions which when executed on a computer cause the computer to execute a method for sharpening a first pixel having a first location on an image, said image comprising a plurality of pixels, each pixel of said plurality of pixels having values for at least two color channels, the method comprising:
defining a region around said first location on said image;
calculating an average projection of vectors defined by the values of pixels in said region onto a first vector defined by said values of said first pixel;
adjusting said values of said first pixel using said average projection.

16. The computer program product of claim 15, the method further comprising calculating a projection matrix, said projection matrix being a projection onto said first vector.

17. The computer program product of claim 15, the method further comprising calculating a difference vector by subtracting said average projection from said first vector.

18. The computer program product of claim 17, said step of adjusting said values of said first pixel comprising adding said difference vector multiplied by a scalar to said first vector.

19. The computer program product of claim 15, said region being defined by a user input.

20. The computer program product of claim 15, the method further comprising calculating a monochrome value for said pixel.
